(19) United States
(12) Patent Application Publication
(10) Pub. No.: US 2007/0050913 A1
(43) Pub. Date: Mar. 8, 2007

(54) Method and composition for bleaching fabric and the fabric produced thereby

(75) Inventor: Peter Margolin, Highland Park, IL (US)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Central Trading Enterprises, Inc.

(21) Appl. No.: 11/413,190

(22) Filed: Apr. 28, 2006

Related U.S. Application Data
(60) Provisional application No. 60/714,262, filed on Sep. 7, 2005.

(51) Int. Cl. C11D 3/00

(52) U.S. Cl. 8/115.51

(57) ABSTRACT

A process for treating fabric and particularly indigo dyed fabric to change its color to a desired shade or cast contacts the fabric with an aqueous solution containing a chlorine-providing compound and an amount of a bromide salt and/or iodide salt. The desired shade of the bleached fabric can be controlled by adjusting the ratio of the bromide salt or iodide salt in relation to the concentration of the chlorine providing compound and the pH of the aqueous solution. In one embodiment, the chlorine-providing compound is sodium hypochlorite and the salt is sodium bromide, potassium bromide, sodium iodide, potassium iodide and mixtures thereof. The salt in combination with the sodium hypochlorite produces a gray cast to the fabric and particularly indigo dyed denim compared to the blue cast of conventional hypochlorite bleaching and reduces the amount of the hypochlorite bleach normally required to attain the desired shade.

### CROSS-REFERENCE TO RELATED APPLICATION

This application claims the benefit of U.S. Provisional Application No. 60/714,262, filed Sep. 7, 2005, which is hereby incorporated by reference in its entirety.

### FIELD OF THE INVENTION

The present invention is directed to a process for bleaching fabrics and to the bleached fabric obtained by the process. The invention is particularly directed to a process for controlling the bleaching of indigo dyed fabrics such as denim to produce a unique appearance with a shade and cast that is not produced by conventional bleaching. The invention is also directed to a process of treating a stonewashed denim to produce a unique shade.

### BACKGROUND OF THE INVENTION

Denim fabric is commonly used in making a number of garments such as jeans. Denim is generally available in blue or black. The blue denim is typically dyed with indigo dye, which after successive washing, becomes softer. The color fades after washing and white areas of the denim fabric become more visible.

The aged and worn texture and appearance is commercially desirable so that manufacturers have developed various techniques and processes to provide the washed and worn appearance. One process washes the denim garments such as jeans with stones, and particularly pumice, to produce what is referred to as a stonewashed appearance.

Another process to produce a worn appearance is by treating the denim with an enzyme such as cellulase. The enzyme reacts with the cellulose in the cotton fibers to release the dye and produce lighter, faded areas or white areas. The cellulase also lightens the blue or black color to produce an appearance similar to stonewashing.

Another method of lightening the color of blue or black denim is by the use of a bleaching agent. The most common bleaching agent is sodium hypochlorite, although other chlorine and non-chlorine bleaching agents can be used. One disadvantage of bleaching with sodium hypochlorite is that the hypochlorite degrades the cotton fibers. The degradation of the cotton results in loss of tensile and tear strength of the fabric and reduces the usable life of the finished garment. Bleaching with sodium hypochlorite of indigo dyed fabrics produces a royal blue or powder blue color to the fabric. The royal or powder blue color is not always desirable in some indigo dyed denim garments. Moreover, the fading of the dye cannot be controlled easily so that it is difficult to attain the dried shade.

Another process is known that can overcome some of the disadvantages of sodium hypochlorite bleaching. This process uses laccase enzyme and a mediator, which overcomes the disadvantage of sodium hypochlorite bleaching since it does not weaken the cotton fibers and does not produce the royal blue or powder blue color. However, laccase-enzyme treated products are expensive and require extensive processing time that typically exceeds 30 minutes. In addition, the shade or cast obtained from the laccase enzyme cannot be controlled or varied. Accordingly, the use of laccase enzyme is limited in commercial processes.

Thus, there is a continuing need in the industry for an improved method for treating fabrics and garments to obtain the desired appearance.

### SUMMARY OF THE INVENTION

The present invention is directed to a process for producing a fabric and garments made from the fabric having a desired color or shade of the color. The invention is particularly directed to a process for bleaching a fabric in a manner that overcomes the disadvantages of the prior processes.

Accordingly, a primary feature of the invention is to provide a method of treating fabric and particularly a denim fabric to economically produce a washed denim fabric appearance in various and different shades and colors. The process can be carried out without multiple steps, and without expensive equipment or large inventories of fabrics and dyes.

Another feature of the invention is to produce denim fabrics and garments of different shades and colors having a stonewashed appearance.

A further feature of the invention is to provide a method for bleaching indigo dyed fabrics in a controlled manner to attain the desired shade and color. The process of the invention produces different results in the denim compared to the prior processes that use sodium hypochlorite bleaching agents as the only bleaching agent.

Another aspect of the invention is to provide a process and a finished fabric or garment obtained by the process of treating the fabric and/or garment with an aqueous solution of sodium hypochlorite and a bromide salt and/or iodide salt. The process produces a gray color to the indigo dyed fabric rather than the typical royal blue or powder blue color of conventional bleaching, and particularly, sodium hypochlorite bleaching.

The foregoing aspects of the invention are basically attained by providing a method of treating indigo dyed fabrics by contacting the indigo dyed fabric with an aqueous mixture including a bleaching agent comprising a chlorine-providing compound and a salt selected from the group consisting of bromide salts, iodide salts and mixtures thereof. In one embodiment, the chlorine-containing bleaching agent is sodium hypochlorite and the salt is sodium bromide, sodium iodide, or a mixture thereof.

The objects of the invention are also attained by providing a method of treating indigo dyed fabrics to produce a faded appearance where the method includes the step of introducing the fabric into a washing apparatus and desizing the fabric, and thereafter contacting the fabric with an aqueous mixture of a chlorine-providing compound and an alkali metal bromide salt or iodide salt. The aqueous mixture is at a temperature of about 10° C. to about 80° C. and a weight ratio of about 1:1 to about 10:1 based on the weight of the fabric. The chlorine-providing compound provides a source of available chlorine in an amount of about 0.01 wt % to about 2.0 wt % based on the weight of the fabric. The resulting fabric is then rinsed with clear water to remove the aqueous mixture from the fabric and then dried to obtain the fabric with the unique faded appearance.

The aspects of the invention are further attained by providing a method of producing a stonewashed denim fabric comprising the steps of washing an indigo dyed denim fabric in the presence of an abrasive or a cellulase enzyme to produce washed denim, and contacting the washed denim with an aqueous mixture including a bleaching agent comprising sodium hypochlorite and an alkali metal bromide or chloride salt for a time sufficient to produce an enhanced stonewashed appearance. The fabric is rinsed to remove the aqueous mixture, and the fabric is dried to produce the stonewashed denim fabric.

The aspects of the invention are also attained by providing a denim fabric having a faded stonewashed appearance prepared by the process of introducing the indigo dyed fabric into a washing apparatus and desizing the indigo dyed fabric and thereafter contacting the fabric with an aqueous mixture including a bleaching agent comprising a chlorine-providing compound and an alkali metal bromide salt, an iodide salt or mixture thereof. The aqueous mixture is introduced at a temperature of about 10° C. to about 80° C. and a weight ratio of about 1:1 to about 10:1 based on the weight of the fabric. The chlorine-providing compound is included in an amount to provide a source of available chlorine in an amount of 0.01 wt % to about 2.0 wt % based on the weight of the fabric. The resulting bleached fabric is then rinsed to remove the aqueous mixture from the fabric and dried to attained the denim fabric having the faded stonewashed appearance.

Other objects, advantages and salient features of the invention will become apparent from the following detailed description which discloses preferred embodiments of the invention.

### DETAILED DESCRIPTION OF THE INVENTION

The present invention is directed to a process for bleaching fabrics and particularly denim fabrics in a controlled manner to attain the desired shade and color. The invention is also directed to the finished fabric having the desired shade and color prepared by the bleaching process.

The invention provides a process for producing a faded indigo dyed fabric and particularly indigo dyed denim in a manner that provides a unique look and appearance that cannot be attained by other processes. The process of the invention reduces the red cast of indigo and instead imparts a green or gray cast to the dyed fabric. The process of the invention can be used on other dyes and fabrics in addition to indigo dyed denim fabric. The resulting appearance obtained by the process is typically a gray cast similar to that obtained with the laccase system which does not produce a royal blue or powder blue cast that is generally obtained on indigo dyed fabrics by sodium hypochlorite bleaching alone. Unlike the laccase method, the process of the invention enables the cast of the dyed fabric to be varied by controlling the pH of the aqueous medium or by changing the ratio of the salt to the hypochlorite chlorine-providing compound. The process of the invention is also suitable for treating dyed fabrics other than indigo dyed fabrics.

The fabrics that are treated by the process of the invention are preferably standard indigo dyed cotton denim fabric that are commercially available from various suppliers. In one embodiment, the denim is previously dyed and dried for commercial use.

The process of the invention provides a bleaching process that causes significantly less damage or degradation to the cotton fibers than normally attained from conventional sodium hypochlorite bleaching. The process of the invention is also cost effective as the processing time is reduced compared to prior processes and the bleaching agents are relatively inexpensive. The process of the invention is also relatively easy to use and provides consistent and controlled results.

The process can be carried out on the fabric itself or finished garments such as jeans and the like. Finished garments are typically treated in a batch process while the fabric can be treated in a continuous process.

The process is carried out by contacting the previously dyed fabric and particularly the indigo dyed fabric with an aqueous solution or aqueous mixture containing a chlorine-providing compound and a salt. The fabric is contacted with the aqueous solution or mixture for sufficient time to bleach the fabric to the desired shade or cast. Typically, the fabric is contacted with the aqueous solution for about 2 minutes to about 30 minutes to attained the desired degree of reaction and color change. The aqueous solution preferably includes a bleaching agent that contains a chlorine-providing compound such as sodium hypochlorite. The concentration of the sodium hypochlorite can vary in the aqueous solution depending on the desired bleaching effect and the nature of the dye in the original fabric. Preferably, the chlorine-providing compound is sodium hypochlorite and is included in an amount to provide a source of available chlorine such that the concentration of the available chlorine in the aqueous solution is about 0.01 wt % and about 2.0 wt % based on the weight of the fabric.

The aqueous solution also includes a salt in an amount to react with the chlorine-providing compound, and particularly, sodium hypochlorite. Preferably, the salt is a bromide or iodide salt of an alkali metal. Typically, the salt is a sodium or potassium bromide salt, sodium or potassium iodide salt, and mixtures thereof. The salts can be added to the solution as a powder or as an aqueous solution. The salt component is included in the aqueous solution in an amount of 0.1 wt % to about 5.0 wt % based on the weight of the fabric being treated. In one embodiment, the salt is added in an amount of about 0.05 wt % to about 0.20 wt % based on the weight of the fabric.

The salt enables the hypochlorite bleaching agent to bleach the fabric using about half the amount of bleach used by conventional bleaching with sodium hypochlorite bleaching to attain a predetermined shade. The amount of the salt added to the aqueous solution and the ratio of the salt in relation to the chlorine-providing compound can be selectively adjusted to control the shade or cast of the resulting bleached fabric.

The chlorine-containing compound of the invention is activated by the presence of the salt. The salt is typically an iodide salt and a bromide salt, and preferably an alkali metal iodide and/or bromide salt. Conventional chlorine bleaching processes use sodium hypochlorite that produce hypochlorous acid in solution. The bleaching activity of hypochlorous acid is inhibited at high pH. The bleaching process of the invention uses an iodide or bromide salt as the activator so that the bleaching action proceeds at a high pH. In the presence of sodium bromide, the sodium hypochlorite forms hypobromous acid as the active bleaching agent. The bleaching activity of hypobromous acid is inhibited less at high pH compared to the same pH of sodium hypochlorite. Therefore, a pH 8.0 to pH 9.0 provides an environment where sodium hypochlorite is discouraged or inhibited from bleaching the indigo dyed fabric. At a high pH of pH 8.0 to pH 9.0, the sodium hypochlorite preferentially reacts with the sodium bromide to produce hypobromous acid as the bleaching agent that is able to bleach indigo dyed fabrics effectively at a relatively high pH. Thus, the sodium bromide in the presence of sodium hypochlorite produces hypobromous acid in situ at a relatively high pH and effectively bleaches indigo dyed fabrics compared to sodium hypochlorite bleaching alone. At lower pH and/or at increased amounts of sodium hypochlorite relative to the amount of sodium bromide allows a portion of the hypochlorous acid to react directly with and bleach the indigo dyed fabric.

The bleaching action by the relative amounts of the hypochlorous acid and hypobromous acid in the system determine the extent of the bleaching and the resulting cast. By raising the pH of the aqueous system, the bleaching action proceeds more by the hypobromous acid and produces a more gray cast then with hypochlorous acid alone. In a similar manner, by lowering the pH, the bleaching action proceeds more by the hypochlorous acid than at high pH to produce a different cast. Similar results of the dyed fabric can be obtained by increasing the amount of the sodium hypochlorite, and thus, the amount of hypochlorous acid in the aqueous system relative to the amount of the salt. While this embodiment refers to the formation of hypobromous acid, it will be understood that the same applies to embodiments using an iodide salt to produce hypoiodous acid in situ in the aqueous system and mixtures of a bromide salt and an iodide salt. Adjusting the amount of the iodide salt in relation to the sodium hypochlorite and adjusting the amount of the iodide salt in relation to the amount of the bromide salt enables the selective adjustment of the cast or hue of the bleached indigo fabric. In a similar manner, adjusting the total amount of the bromide and iodide salt in relation to the amount of the sodium hypochlorite in the aqueous system will also selectively adjust the cast or hue of the indigo dyed fabric.

In one embodiment of the invention, the aqueous solution consists essentially of water, a chlorine-providing compound and a salt selected from the group consisting of sodium bromide, potassium bromide, sodium iodide, potassium iodide, and mixtures thereof. In another embodiment, the aqueous solution consists essentially of water, sodium hypochlorite, and a salt selected from the group consisting essentially of sodium bromide, sodium iodide, potassium bromide, potassium iodide, and mixtures thereof where the salt is included in an amount sufficient to bleach the fabric to the desired cast or hue. The aqueous solution of the chlorine-providing compound and the salt is typically in the absence of a dye or other coloring agent.

In one embodiment, the aqueous solution also includes a buffering agent to adjust the pH of the solution to about pH 4.0 to about pH 12.0, and preferably about pH 8.0 to pH 9.0. In one embodiment, the pH is at least about pH 8.0. The pH of the aqueous solution can be adjusted as desired to obtain the desired bleaching effect by controlling the reaction between the sodium hypochlorite and the iodide or bromide salt to produce hypochlorous acid, hypobromous acid and hypoiodous acid in the desired amounts to obtain the desired bleaching effect. It has been found that the pH of the aqueous solution can be used to control the rate of the bleaching effect such that lighter or darker shades can be attained by the bleaching process. In addition, the concentration of the bromide and/or iodide salt in the aqueous solution in relation to the amount of the chlorine-providing compound affects the bleaching process. It has been found that increasing the salt concentration increases the reaction rate and the speed of the bleaching while reducing the amount of the chlorine-providing compound normally required to attain the same or similar bleaching effect. Therefore, the concentration of the bromide and/or iodide salt in relation to the chlorine-providing compound can be adjusted to control and selectively adjust the shade or cast of the finished fabric in the bleaching process.

The process uses an aqueous treating solution containing a chlorine-providing compound and an amount of a bromide and/or iodide salt to produce a gray faded color. The addition of the bromide and/or iodide salt to the bleaching agent and particularly to sodium hypochlorite is able to produce a gray color and shade using half the amount of the bleaching agent normally required to achieve the same shade. The addition of the bromide and/or iodide salts to the aqueous solution produces the gray cast or color to an indigo dyed denim fabric compared to the typical blue cast of conventional bleaching of indigo dyed blue. In one embodiment, the aqueous bleaching solution contains sodium hypochlorite and about 0.1 to about 5.0 wt % of a bromide or iodide salt based on the weight of fabric where the shade of the bleaching effect can be attained using half or less then half of the amount of sodium hypochlorite in the absence of the salts to attained the same shade. By reducing the amount of the sodium hypochlorite normally required to attain the desired level of bleaching, the destructive or degradation properties of hypochlorite bleach on cellulose fibers is reduced while producing shades and casts that can be obtained only by the use of the bromide and iodide salts.

The buffering agent can be any conventional buffering agent as known in the art. Examples of suitable buffering agents include trisodium phosphate or monosodium phosphate. Other buffering agents can include sodium citrate and citric acid. The buffering agent can be selected according to the desired pH and the desired shade of the finished fabric since the pH of the aqueous solution has a direct effect on the formation of hypobromous acid and hypoiodous acid and the bleaching of the fabric.

In addition to the bromide and/or iodide salt added to the aqueous solution of the chlorine providing bleaching agent, the aqueous solution can contain additional components such as detergents, chelating agents, surfactants and corrosion inhibitors. For example, sodium sulfamate or sulfonic acid can be added as a cleaning agent to the aqueous solution. Sodium tripolyphosphate or tetrasodium pyrophosphate can be added as a metal chelating agent and/or buffering agent. Sodium nitrite can be added as a corrosion inhibitor. A bleach stable surfactant can be added such as an anionic surfactant. In other embodiments, optional brighteners can be added to the aqueous solution to provide a different appearance in addition to the bleached and faded appearance. Examples of suitable optical brighteners are compounds derived from diaminostylbene disulfonic acid or distearyl benzene.

The process of the invention in one embodiment treats garments made from indigo dyed denim or other fabrics using commercially available equipment. In one embodiment, a nominal 550 pound industrial washing machine can be loaded with garments in an amount of about 50 pounds to about 500 pounds. The garments are desized by washing or other desizing processes. In one embodiment, pumice, stones and/or cellulase enzyme can be added to the washing machine with an amount of water to produce an abraded or stonewashed effect. The pumice is then removed and the fabric rinsed to remove the cellulase enzyme. The aqueous solution containing the chlorine providing bleaching agent and the bromide and/or iodide salts are added to the washing machine at a temperature of about 10° C. to about 80° C. in a weight ratio of water to the garments of about 1:1 to about 10:1. The volume of the aqueous solution is typically referred to as the liquor ratio.

The aqueous bleaching solution added to the fabric in the washing machine preferably contains sodium or potassium salts of bromide and/or iodide in an amount of 0.1% to about 5.0% based on the weight of the garments. In one embodiment, the total amount of the bromide salt and/or iodide salt is present in an amount of about 0.1 wt % to about 0.5 wt % based on the weight of the fabric or garments. A buffering agent can be added to adjust the pH to about pH 4.0 to about pH 12.0, and preferably about pH 8.0 to pH 9.0. The aqueous bleaching solution preferably contains sodium hypochlorite to provide an available chlorine concentration in the aqueous solution of about 0.01% to about 2.0% by weight based on the weight of the fabric. The sodium hypochlorite is included in an amount to react with the salt to produce the hypobromous and/or hypoiodous acid in amounts to obtain the desired bleaching effect. The sodium hypochlorite is included in an amount to react with the salt to produce the hypobromous and/or hypoiodous acid in amounts to obtain the desired bleaching effect. The garments are agitated in the washing machine in the presence of the aqueous solution for a period of time sufficient to attain the desired degree of bleaching and to obtain the desired cast or shade. Typically, the washing machine is operated for about 2 minutes to about 30 minutes. In one embodiment, an additional amount of sodium hypochlorite can be added to the aqueous solution and the processing time increased or repeated a number of times to attain the desired bleaching effect. After the desired treatment time, the water is drained from the washing machine and the garments are rinsed and removed from the washing machine and dried in an industrial drier. In one embodiment after the treatment with the aqueous solution of the present invention, a conventional bleaching solution such as a sodium hypochlorite solution can be added to the washing machine to attained the desired shade of the garment. Abrasives can also be added to provide the desired scouring, followed by rinsing with softeners to obtain the finished fabric or garment.

In one embodiment, the aqueous solution used to treat and bleach the dyed fabric or garments consists essentially of an aqueous mixture of about 0.1 wt % to about 5.0 wt % of a bromide salt, iodide salt, or mixture thereof, based on the weight of the fabric or garments, and a chlorine-providing compound in an amount to provide an available chlorine concentration of about 0.01% to about 2.0% by weight. The chlorine-providing bleach is preferably sodium hypochlorite. In another embodiment, the aqueous bleach solution consists essentially of an aqueous solution of a bromide salt, an iodide salt, or a mixture thereof in an amount of about 0.1 wt % to about 0.5 wt % based on the weight of the fabric or garments and sodium hypochlorite in an amount to provide an available chlorine concentration of 0.01% to about 2.0% by weight.

In one embodiment, the denim fabric is initially washed with pumice or cellulase enzyme to produce a stonewashed appearance. The stonewashed denim is then washed or treated with low doses of the aqueous solution of sodium hypochlorite and a bromide and/or iodide salt. The aqueous solution removes back staining and dye redeposition that can occur during the abrasion with the pumice. The treatment with the aqueous solution greatly enhances the stonewashed appearance and can reduce the time normally required for the abrasion by the pumice while producing a similar appearance. The aqueous solution can be used to treat stonewashed denim to produce an enhanced or stonewashed appearance rather than mere bleaching. In this embodiment, the aqueous solution contains about 0.05 wt % to about 0.20 wt % of a bromide or iodide salt, such as, sodium bromide and sodium hypochlorite in an amount to provide available chlorine in an amount of 0.1 wt % to about 0.3 wt % based on the weight of the fabric.

### EXAMPLE 1

Denim jeans were added to a washing machine containing water, pumice and cellulase enzyme for 45 minutes. The stonewashed jeans were then rinsed and removed. The stonewashed jeans were then treated with an aqueous solution containing 18 wt % of a 10% sodium hypochlorite solution based on the weight of the jeans. The jeans exhibited a generally powder blue shade.

### EXAMPLE 2

Stonewashed denim jeans were produced as in Example 1. The stonewashed denim jeans were with an aqueous solution containing 8 wt % of a 10 wt % sodium hypochlorite solution and 0.2 wt % sodium bromide based on the weight of the denim. The denim jeans exhibited a gray-blue cast compared to the jeans obtained in Example 1.

### EXAMPLE 3

Stonewashed denim jeans were produced as in Example 1 and treated with an aqueous solution containing 6 wt % of a 10 wt % sodium hypochlorite solution and 0.2 wt % sodium bromide based o the weight of the denim jeans. The resulting denim jeans exhibited a slightly darker hue or cast compared to the denim jeans of Examples 1 and 2 and a gray-blue cast compared to the jeans of Example 1.

### EXAMPLE 4

Stonewashed denim jeans were obtained as in Example 1 and treated with an aqueous solution of 15 wt % of a 10 wt % sodium hypochlorite solution based on the weight of the denim jeans. The resulting jeans had a slightly darker but similar blue cast or hue as the jeans in Example 1. The jeans of Examples 2 and 3 had a gray-blue cast compared to the blue cast jeans of Example 4.

The resulting bleached fabric garments can be produced having selected shades and colors by varying the dose of the bleaching agent, pH, temperature, time and ratio of the bromide or iodide salt to the sodium hypochlorite. The process of the invention is able to provide a desired shade lighter with a case or hue that is different than an indigo dyed denim that is treated by a conventional wet processing that includes desizing and abrasion with pumice and cellulase enzymes.

While various embodiments have been chosen to illustrate the invention, it will be understood by those skilled in the art that various changes and modifications can be made therein without departing from the scope of the invention as defined in the appended claims.

What is claimed is:

1. A method of treating dyed fabric comprising the step of:
contacting the dyed fabric with an aqueous mixture comprising a bleaching agent, the bleaching agent including a chlorine-providing compound and a salt selected from the group consisting of bromide salts, iodide salts, and mixtures thereof, for a time sufficient to produce a faded bleached fabric having a gray cast.

2. The method of claim 1, wherein the chlorine-providing compound is sodium hypochlorite.

3. The method of claim 1, wherein the salt is an alkali metal bromide or chloride salt.

4. The method of claim 1, wherein the aqueous mixture has a pH of about pH 4.0 to about pH 12.0.

5. The method of claim 1, wherein the aqueous mixture has a pH of about pH 8.0 to about pH 9.0.

6. The method of claim 1, wherein the chlorine-providing compound is present to provide available chlorine in an amount to provide about 0.01 wt % to about 2.0 wt % based on the weight of the fabric.

7. The method of claim 1, wherein the salt is an alkali metal salt present in an amount of about 0.1 wt % to about 5.0 wt % based on the weight of the fabric.

8. The method of claim 1, wherein said bleaching agent is sodium hypochlorite in an amount to provide about 0.01 wt % to about 2.0 wt % available chlorine, a pH of about pH 4.0 to pH 12.0, and a sodium or potassium bromide salt in an amount of 0.1 wt % to about 5.0 wt %, wherein the percentages are based on the weight of the fabric.

9. The method of claim 1, wherein the bleaching agent consists essentially of sodium hypochlorite, and a salt selected from the group consisting of sodium bromide, potassium bromide, sodium iodide, potassium iodide, and mixtures thereof.

10. The method of claim 1, wherein the aqueous mixture has a pH of about pH 8.0 to about pH 9.0.

11. The method of claim 1, wherein the chlorine-providing compound is sodium hypochlorite and the salt is selected from the group consisting of sodium bromide, potassium bromide, sodium iodide, potassium iodide, and mixtures thereof, and wherein the salt is present in an amount to produce hypobromous acid, hypoiodous acid, and mixtures thereof in the aqueous mixture in an effective amount to bleach the fabric.

12. The method of claim 1, wherein the fabric is indigo dyed denim.

13. The method of claim 1, wherein the fabric is finished denim garments.

14. The method of claim 1, wherein the fabric is stonewashed indigo dyed denim.

15. A method of treating indigo-dyed denim fabric to produce a faded appearance with a gray cast, the method comprising the steps of:
introducing the denim fabric into a washing apparatus and desizing the fabric,
contacting the fabric with an aqueous mixture at a temperature of about 10° C. to about 80° C. in a weight ratio of about 1:1 to about 10:1 based on the weight of the fabric, the aqueous mixture including a bleaching agent comprising an alkali metal bromide salt, iodide salt or mixture thereof and a chlorine-providing compound to provide a source of available chlorine in an amount of 0.01 wt % to about 2.0 wt % based on the weight of the fabric,
rinsing the fabric to remove the aqueous mixture from the fabric, and
drying the fabric to obtain the fabric with the faded appearance with a gray cast.

16. The method of claim 15, wherein the chlorine-providing compound is sodium hypochlorite.

17. The method of claim 15, wherein the alkali metal bromide is sodium bromide and the iodide salt is sodium iodide.

18. The method of claim 15, wherein the alkali metal bromide salt, iodide salt or mixture thereof are included in an amount of about 0.1 wt % to about 5.0 wt % based on the weight of the fabric.

19. The method of claim 15, wherein the aqueous mixture has a pH of about pH 4.0 to about pH 12.0.

20. The method of claim 15, wherein the aqueous mixture has a pH of about pH 8.0 to about pH 9.0.

21. The method of claim 15, wherein the chlorine-providing compound is sodium hypochlorite and wherein the alkali metal salt is present in an amount to produce hypobromous acid or hypoiodous acid in the mixture in an amount effective to bleach the fabric.

22. The method of claim 15, wherein the fabric is stonewashed denim.

23. The method of claim 15, wherein the fabric is finished denim garments.

24. A denim fabric produced according to the method of claim 13.

25. The method of claim 15, wherein the bleaching agent consists essentially of the alkali metal bromide salt or iodide salt and the chlorine-providing compound, and wherein the chlorine providing compound is sodium hypochlorite.

26. The method of claim 15, further comprising washing the fabric in the presence of an abrasive, a cellulase enzyme, or mixture thereof prior to contacting the fabric with the aqueous mixture.

27. A method of producing a stonewashed denim fabric comprising the steps of:
washing an indigo dyed denim fabric in the presence of an abrasive, a cellulase enzyme, or mixture thereof to produce washed denim, and
contacting the washed denim with an aqueous mixture including a bleaching agent comprising sodium hypochlorite and an alkali metal bromide or chloride salt for a time sufficient to produce an enhanced stonewashed appearance,
rinsing the fabric to remove the aqueous mixture, and
drying the fabric to produce the stonewashed denim fabric.

28. The method of claim 27, wherein the sodium hypochlorite is included in an amount to provide available chlorine in an amount of about 0.1 wt % to about 0.3 wt % and wherein the alkali metal salt is present in an amount of about 0.05 wt % to about 0.20 wt %, where the percentages are based on the weight of the fabric.

29. The method of claim 27, wherein the bleaching agent consists essentially of sodium hypochlorite and the alkali metal bromide or chloride salt.

30. The method of claim 27, wherein the aqueous mixture has a pH of about pH 8.0 to about pH 9.0

31. The method of claim 27, wherein the sodium hypochlorite and the alkali metal bromide or iodide salt are present in an amount to produce hypobromous acid and hypoiodous acid in the aqueous mixture in amounts sufficient to treat the fabric and produce a gray cast.

32. A denim fabric having a faded stonewashed appearance prepared by the process of:
introducing indigo dyed denim fabric into a washing apparatus and desizing the indigo dyed fabric,
contacting the fabric with an aqueous mixture at a temperature of about 10° C. to about 80° C. in a weight ratio of about 1:1 to about 10:1 based on the weight of the fabric, the aqueous mixture including a bleaching agent comprising an alkali metal bromide salt, iodide salt or mixture thereof and a chlorine providing bleaching agent to provide a source of available chlorine in an amount of 0.01 wt % to about 2.0 wt % based on the weight of the fabric,
rinsing the fabric to remove the aqueous mixture from the fabric, and drying the fabric.

33. The denim fabric of claim 32, wherein the alkali metal is sodium and the salt is included in an amount of about 0.1 wt % to about 5.0 wt % based on the weight of the fabric.

34. The denim fabric of claim 32, wherein the bleaching agent consists essentially of the sodium hypochlorite and the alkali bromide salt, iodide salt or mixture thereof.
